(19) United States
(12) Patent Application Publication
(10) Pub. No.: US 2026/0213049 A1
(43) Pub. Date: Jul. 23, 2026

(54) CHIP RESISTOR

(71) Applicant: Panasonic Intellectual Property Management Co., Ltd., Osaka (JP)

(72) Inventors: YASUHARU KINOSHITA, Fukui (JP); KENTARO TAMAMURA, Fukui (JP)

(21) Appl. No.: 19/142,623

(22) PCT Filed: Jan. 26, 2024
(86) PCT No.: PCT/JP2024/002315

§ 371 Date: Jun. 23, 2025

(30) Foreign Application Priority Data
Jan. 31, 2023 (JP) 2023-013509
Mar. 31, 2023 (JP) 2023-058372

(51) Int. Cl. H01C 1/148

(52) U.S. Cl. CPC H01C 1/148

(57) ABSTRACT

A resistive element of a chip resistor includes a resistance value adjusting part. The resistance value adjusting part includes a meandering part. In the meandering part, a first trimming groove and a second trimming groove are arranged along a first direction (longitudinal direction). The first trimming groove includes a first straight part extending from a second edge of the resistance value adjusting part along a second direction (short direction). The second trimming groove includes a second straight part and a bent part. The second straight part extends from a second edge of the resistance value adjusting part in the second direction. The bent part extends from a tip end of the second straight part in a direction approaching the first trimming groove.

### TECHNICAL FIELD

The present disclosure relates to a chip resistor and a method for manufacturing a chip resistor, and particularly to a chip resistor including a pair of electrodes and a resistive element and a method for manufacturing the chip resistor.

### BACKGROUND ART

PTL 1 discloses a chip resistor including a resistive element provided on an insulating substrate. The resistive element has a straight trimming groove formed in a rectangular part of the resistive element.

PTL 2 discloses a chip resistor including a resistive element provided on an insulating substrate. the resistive element has a straight trimming groove formed in a rectangular part of the resistive element.

### CITATION LIST

### Patent Literature

PTL 1: Japanese Patent Laid-Open Publication No. 2010-135358
PTL 2: Japanese Patent Laid-Open Publication No. 2005-244060

### SUMMARY OF INVENTION

In the chip resistor described in PTL 1, the trimming groove forms a meandering pattern in the rectangular part of a resistive element. The trimming groove is formed by, for example, laser. In the chip resistor described in PTL 1, two parallel trimming grooves are formed for finely adjusting a resistance value.

The laser used for forming the trimming grooves technically prevents widening of the width of the trimming groove. Therefore, the withstand voltage of the trimming groove is hardly increased, so that the withstand voltage of the trimming groove may become a voltage limitation of the chip resistor.

In the chip resistor described in PTL 2, the resistive element includes a pair of rectangular parts and a meandering part between the rectangular parts. The trimming groove forms a meandering pattern in the rectangular parts of the resistive element. The trimming groove is formed, for example, by laser.

The laser used for forming a trimming groove technically prevents widening of the width of the trimming groove. Therefore, it is difficult to increase the withstand voltage of the trimming groove, so that the withstand voltage of the trimming groove may become a voltage limitation of the chip resistor.

A chip resistor according to an aspect of the present disclosure includes a substrate, a pair of electrodes, and a resistive element. The pair of electrodes are provided on both ends of one surface of the substrate. The resistive element is provided on the one surface of the substrate between the pair of electrodes. The resistive element includes a pair of connection parts connected to the pair of electrodes, respectively, and a resistance value adjusting part provided between the pair of connection parts. The resistance value adjusting part includes a meandering part providing the resistance value adjusting part with a meandering shape. The meandering part has a first trimming groove and a second trimming groove therein. The first trimming groove and the second trimming groove are arranged along a first direction in which the pair of connection parts are arranged. The first trimming groove includes a first straight part extending from a groove-starting edge of the resistance value adjusting part along a second direction perpendicular to the first direction. The second trimming groove includes a second straight part and a bent part, the second straight part extending from the groove-starting edge of the resistance value adjusting part along the second direction, the bent part extending from a tip end of the second straight part in a direction approaching the first trimming groove.

The present disclosure provides a chip resistor with a high withstand voltage.

A chip resistor according to an aspect of the present disclosure includes a substrate, first and second electrodes, and a resistive element. The first and second electrodes are provided on both ends of one surface of the substrate in the first direction. The resistive element is provided on the one surface of the substrate between the first and second electrodes. The resistive element includes a meandering part and a first rectangular part connected to the meandering part and the first electrode. The first rectangular part has a first trimming groove and a second trimming groove provided therein extending along a second direction perpendicular to the first direction from a first edge of the first rectangular part extending in the first direction part, the first trimming groove and the second trimming groove providing the first rectangular part with a meandering shape.

A method for manufacturing a chip resistor according to an aspect of the present invention includes: forming a first electrode and a second electrode on both ends of one surface of a substrate in a first direction; forming, on a middle of the one surface of the substrate in the first direction, a resistive element including a meandering part and a rectangular part connected to the meandering part and the first electrode; and forming a first trimming groove and a second trimming groove in the rectangular part, the first trimming groove and the second trimming groove extending along a second direction perpendicular to the first direction from an edge of the rectangular part extending in the first direction so as to provide the rectangular part with a meandering shape.

The present disclosure provides a chip resistor with high withstand voltage and a method for manufacturing the chip resistor.

### BRIEF DESCRIPTION OF DRAWINGS

FIG. 1 is a schematic sectional view of a chip resistor according to a first exemplary embodiment of the present disclosure.

FIG. 2 is a schematic top view of the chip resistor.

FIG. 3 is a graph showing a change of a resistance value with respect to a total distance of trimming.

FIG. 4 is a graph showing a change of a potential difference between both sides of each groove with respect to a change of the ratio of a length of a second trimming groove to a length of a first trimming groove.

FIG. 5 is a schematic top view of a chip resistor according to a second exemplary embodiment of the present disclosure.

FIG. 6 is a schematic top view of a chip resistor according to a third exemplary embodiment of the present disclosure.

FIG. 7 is a schematic top view of a chip resistor according to a fourth exemplary embodiment of the present disclosure.

FIG. 8 is a schematic top view of a chip resistor according to a fifth exemplary embodiment of the present disclosure.

FIG. 9 is a schematic perspective view of a chip resistor according to a sixth exemplary embodiment of the present disclosure.

FIG. 10 is a graph showing a change of a potential difference between both sides of each groove with respect to a length of the second one of the trimming grooves of the chip resistor in the sixth exemplary embodiment of the present disclosure.

FIG. 11 is a schematic perspective view of a chip resistor according to a seventh exemplary embodiment of the present disclosure.

FIG. 12 is a graph showing a change of a resistance value variation rate with respect to a crack length of the chip resistor according to the seventh exemplary embodiment of the present disclosure.

FIG. 13 is a schematic perspective view a chip resistor according to an eighth exemplary embodiment of the present disclosure.

FIG. 14 is a schematic perspective view of a chip resistor according to a ninth exemplary embodiment of the present disclosure.

### DESCRIPTION OF EMBODIMENT

Chip resistor according to exemplary embodiments of the present disclosure will be described below with reference to drawings. Each figure described in the following exemplary embodiments is a schematic diagram, and the ratio of the size and thickness of each component does not necessarily reflect the actual dimensional ratio. Furthermore, the configurations described in the following exemplary embodiments are merely an example of the present disclosure. The present disclosure is not limited to the following exemplary embodiments, and various modifications are possible depending on the design, and the like, as long as the advantageous effects of the present disclosure can be achieved.

An X-axis, a Y-axis, and a Z-axis in each drawing are perpendicular to one another, but the configuration is just an example and is not intended to specify the direction of the chip resistor during use.

### First Exemplary Embodiment

### (1-1) Basic Configuration of Chip Resistor

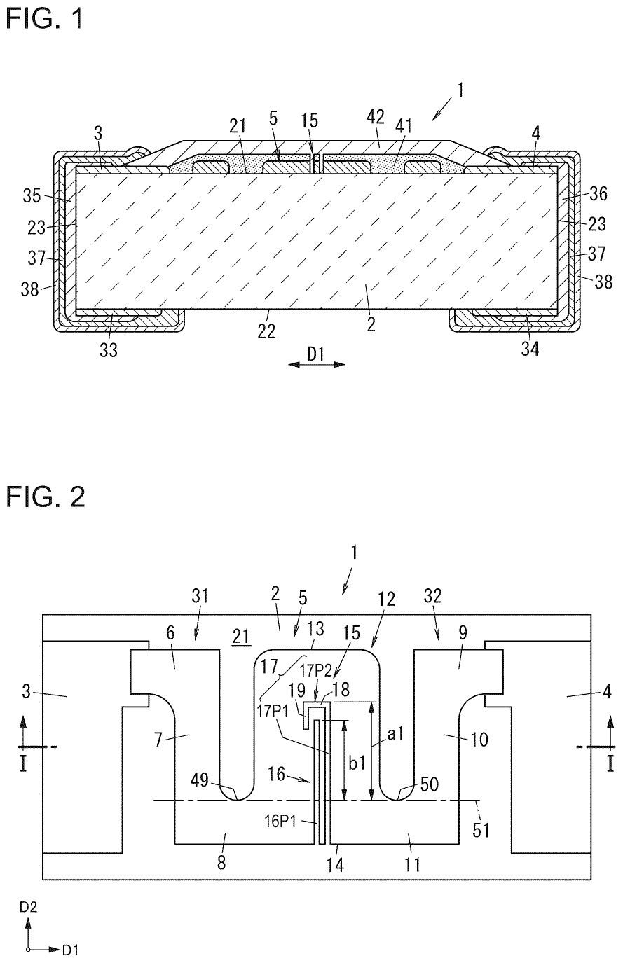

A first exemplary embodiment will be described below with reference to FIGS. 1 and 2. The first exemplary embodiment discloses chip resistor 1 including a resistive element having a groove formed therein to provide the resistive element with a meandering shape.

Chip resistor 1 is a chip resistor for, e.g., Surface Mount Technology (SMT), which is to be mounted on a surface (mount surface) of a printed circuit board with a surface mounting machine (mounter). In accordance with this embodiment, chip resistor 1 is a thick-film chip resistor.

As shown in FIGS. 1 and 2, chip resistor 1 includes insulating substrate 2, first upper surface electrode 3, second upper surface electrode 4, and resistive element 5. As shown in FIG. 1, chip resistor 1 further includes first lower surface electrode 33, second lower surface electrode 34, first end surface electrode 35, second end surface electrode 36, a pair of first plating layers 37, and a pair of second plating layers 38. As shown in FIG. 1, chip resistor 1 further includes glass protective film 41 and resin protective film 42.

### (1-2) Insulating Substrate

Insulating substrate 2 is made of, for example, alumina containing 96% Al₂O₃, and has a rectangular shape (when viewed from above). The left and right directions of FIGS. 1 and 2 will be referred to as a longitudinal direction D1 (a first direction) below, and the up and down directions in FIG. 2 will be referred to as a short direction D2 (a second direction) below. The right side of FIGS. 1 and 2 will be referred to as a first side in the longitudinal direction, the left side of FIGS. 1 and 2 will be referred to as a second side in the longitudinal direction, the upper side of FIG. 2 will be referred to as a first side in the short direction, and the lower side of FIG. 2 will be referred to as a second side in the short direction.

The longitudinal direction D1 and the short direction D2 are perpendicular to each other. The concept of “perpendicular” here includes substantially perpendicular, and includes a range of 90°±10°.

### (1-3) Upper Surface Electrodes, Lower Surface Electrodes, and Side Surface Electrodes

First upper surface electrode 3 and second upper surface electrode 4 are provided on both end parts of surface 21 of insulating substrate 2 in the longitudinal direction, and are formed by printing and firing a thick-film material containing metal, such as silver.

First lower surface electrode 33 and second lower surface electrode 34 are provided on both end parts of rear surface 22 of insulating substrate 2, respectively, and are formed by printing and firing a thick-film material containing metal, such as silver. First lower surface electrode 33 and second lower surface electrode 34 correspond to first upper surface electrode 3 and second upper surface electrode 4, respectively.

First end surface electrode 35 and second end surface electrode 36 are provided on a pair of end surfaces 23 on both sides in the longitudinal direction of insulating substrate 2, respectively. First end surface electrode 35 and second end surface electrode 36 are made of, for example, sputtered film made of NiCr. In other words, first end surface electrode 35 and second end surface electrode 36 are formed (film-formed) by sputtering on end surfaces 23 in the left-right direction of insulating substrate 2. First end surface electrode 35 electrically connects first upper surface electrode 3 to first lower surface electrode 33. Second end surface electrode 36 electrically connects second upper surface electrode 4 to second lower surface electrode 34.

### (1-4) Resistive Element

Resistive element 5 is formed on surface 21 of insulating substrate 2 between first upper surface electrode 3 and second upper surface electrode 4, and is connected to first upper surface electrode 3 and second upper surface electrode 4. Resistive element 5 is formed by printing a thick-film material made of copper-nickel, silver-palladium, or ruthenium oxide on surface 21 of insulating substrate 2, and then firing the printed material.

Resistive element 5 includes resistance value adjusting part 12, first connection part 31, and second connection part 32.

Resistance value adjusting part 12 is disposed on the middle of surface 21 of insulating substrate 2 in the longitudinal direction, that is, between first upper surface electrode 3 and second upper surface electrode 4 apart from first upper surface electrode 3 and second upper surface electrode 4. More specifically, resistance value adjusting part 12 is provided between first connection part 31 and second connection part 32. Resistance value adjusting part 12 is a section for adjusting a resistance value of resistive element 5 by laser trimming, as described below. An edge of resistance value adjusting part 12 on the first side in the short direction is referred to as first edge 13, and an edge of resistance value adjusting part 12 on the second side in the short direction is referred to as second edge 14 (an example of a groove-starting edge).

First connection part 31 and second connection part 32 are arranged in the longitudinal direction D1. First connection part 31 includes first rectangular part 6, second rectangular part 7, and third rectangular part 8 (an example of the connection section). First rectangular part 6 is connected to a first side section in the short direction of first upper surface electrode 3, and extends toward a first side of the longitudinal direction. Second rectangular part 7 extends from a tip end of first rectangular part 6 toward a second side of the short direction. Third rectangular part 8 extends from a tip end of second rectangular part 7 toward a first side of the longitudinal direction and is connected to an end part of resistance value adjusting part 12 in a second side of the short direction (an end part close to second edge 14). Third rectangular part 8 includes edge 49 (an example of the edge) at a first side in the short direction. Edge 49 is an edge opposite to second edge 14 in the short direction D2.

Second connection part 32 includes fourth rectangular part 9, fifth rectangular part 10, and sixth rectangular part 11 (an example of the connection section). Fourth rectangular part 9 is connected to of second upper surface electrode 4 at a first side section in the short direction of second upper surface electrode 4 and extends toward a second side in the longitudinal direction. Fifth rectangular part 10 extends from a tip end of fourth rectangular part 9 toward a second side in the short direction. Sixth rectangular part 11 extends from a tip end of fifth rectangular part 10 toward a second side in the longitudinal direction and is connected to an end part of resistance value adjusting part 12 at a second side in the short direction of resistance value adjusting part 12 (an end part close to second edge 14). In the above-mentioned configuration, sixth rectangular part 11 is provided in the vicinity of second edge 14 of resistance value adjusting part 12. Sixth rectangular part 11 includes edge 50 (an example of the edge) at a first side in the short direction. Edge 50 is an edge opposite to second edge 14 in the short direction D2. Positions of edge 49 of third rectangular part 8 and edge 50 of sixth rectangular part 11 in the short direction are voltage reference position 51.

Resistance value adjusting part 12 includes meandering part 15 providing resistance value adjusting part 12 with a meandering shape. Resistive element 5 has a meandering shape folded back three times in directions parallel to the short direction D2 of insulating substrate 2. Specifically, first rectangular part 6, second rectangular part 7, third rectangular part 8, and resistance value adjusting part 12 form the first turn folded back toward the first side in the short direction. Fourth rectangular part 9, fifth rectangular part 10, sixth rectangular part 11, and resistance value adjusting part 12 form the second turn folded back toward the first side in the short direction. In addition, resistance value adjusting part 12 forms the third turn folded back toward the second side in the short direction as described below.

Meandering part 15 has two trimming grooves provided therein. Meandering part 15 has first trimming groove 16 and second trimming groove 17 provided therein. First trimming groove 16 and second trimming groove 17 are arranged in the longitudinal direction D1.

First trimming groove 16 includes first straight part 16P1 extending from second edge 14 of resistance value adjusting part 12 along the short direction D2 (an example of the second direction).

Second trimming groove 17 includes second straight part 17P1 extending from second edge 14 of resistance value adjusting part 12 along the short direction D2, and bent part 17P2 (an example of the folded part) extending from a tip end of second straight part 17P1 in the direction approaching first trimming groove 16.

The length of second straight part 17P1 of second trimming groove 17 in the short direction D2 is larger than the length of first straight part 16P1 of first trimming groove 16 in the short direction D2.

Bent part 17P2 of second trimming groove 17 is opposite to second edge 14 with respect to the tip end of first straight part 16P1 of first trimming groove 16.

The above configuration reduces the potential difference between both sides of each trimming groove in meandering part 15. This configuration provides a meandering pattern that can withstand a high potential difference.

Bent part 17P2 of second trimming groove 17 includes first section 18 bent perpendicularly from a tip end of second straight part 17P1 and extending toward a second side in the short direction. The tip end of first section 18 is located closer to the second side in the longitudinal direction than the tip end of first straight part 16P1 of first trimming groove 16.

Bent part 17P2 of second trimming groove 17 further includes second section 19 extending from the tip end of first section 18 and being folded back toward second straight part 17P1. Second section 19 extends from the tip end of first section 18 toward the second side in the short direction. Specifically, second section 19 is a straight line extending in parallel to second straight part 17P1. More specifically, a tip end of second section 19 is located closer to the second side in the short direction than the tip end of first straight part 16P1. That is to say, in a tip end section of first straight part 16P1, both sides in the longitudinal direction and the first side in the short direction are surrounded by second trimming groove 17.

As shown in FIGS. 2, 0.53<a1/b1≤1.30 is satisfied where a1 is a length of second trimming groove 17 in the short direction from voltage reference position 51 to a tip end of second trimming groove 17, and b1 is a length of first trimming groove 16 in the short direction from voltage reference position 51 to a tip end of first trimming groove 16.

In this case, since the potential difference between both sides of each trimming groove is reduced as compared with a conventional example using two trimming grooves, a voltage breakdown is less likely to occur in a groove section, and therefore characteristic abnormality can be suppressed.

### (1-5) Glass Protective Film

Glass protective film 41 is configured to protect resistive element 5. As shown in FIG. 1, glass protective film 41 covers the entire region (whole) of resistive element 5. Glass protective film 41 is made of, for example, lead oxide glass. Glass protective film 41 is formed (film-formed) by, for example, screen printing. Glass protective film 41 is not necessarily made of lead oxide glass, and may be made of, for example, silicate glass.

### (1-6) Resin Protective Film

Resin protective film 42 is made of, for example, epoxy resin, and covers the entire region (whole) of glass protective film 41. Resin protective film 42 is formed (film-formed) by, for example, applying epoxy resin by screen printing and then thermally curing the epoxy resin.

### (1-7) First Plating Layer

A pair of first plating layers 37 is made of, for example, nickel (Ni) plating. The pair of first plating layers 37 cover first end surface electrode 35 and second end surface electrode 36 at both ends of insulating substrate 2 in the longitudinal direction, respectively.

### (1-8) Second Plating Layer

A pair of second plating layers 38 is made of, for example, tin (Sn) plating. The pair of second plating layers 38 cover the pair of first plating layers 37 at both ends of insulating substrate 2 in the longitudinal direction D1, respectively.

### (1-9) Method for Manufacturing Chip Resistor

A method for manufacturing chip resistor 1 will be described below. For simplifying the description, only formations of first upper surface electrode 3, second upper surface electrode 4, and resistive element 5 are described.

Firstly, electrode paste is screen printed on both ends in the longitudinal direction of insulating substrate 2 made of alumina, and then, fired at 850° C. to form first upper surface electrode 3 and second upper surface electrode 4.

Next, a resistive paste is screen printed between first upper surface electrode 3 and second upper surface electrode 4, and then, fired at 850° C. to form resistive element 5.

Next, in order to form resistance value adjusting part 12 having a meandering shape, meandering part 15 is formed by laser trimming. Thus, resistive element 5 has a meandering shape with three turns.

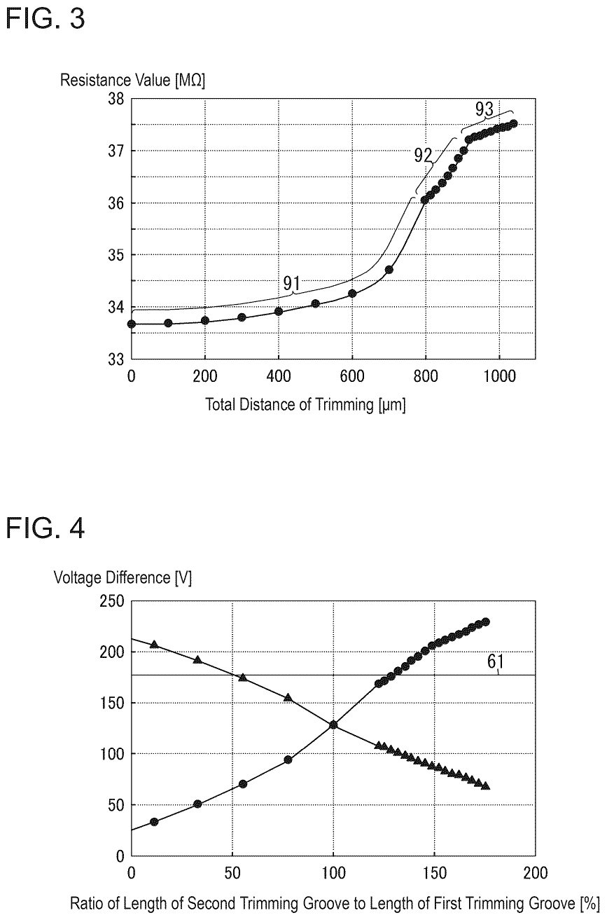

The formation of second trimming groove 17 will be described with reference to FIG. 3. In accordance with this embodiment, second straight part 17P1, first section 18 of bent part 17P2, and second section 19 of bent part 17P2 are trimmed with laser in this order. In FIG. 3, a change of the resistance value denoted by reference numeral 91 is observed when second straight part 17P1 is formed, a change in the resistance value denoted by reference numeral 92 is observed when first section 18 is formed, and a change in the resistance value denoted by reference numeral 93 is observed when second section 19 is formed. These changes show that the resistance value of resistive element 5 is finely adjusted by forming first section 18 and second section 19.

### (1-10) Characteristics

A change of a potential difference between both sides of each groove with respect to a change of the ratio (%) of the length of second trimming groove 17 to the length of first trimming groove 16 will be described with reference to FIG. 4. This result was obtained by a simulation of a case of applying 800 V to resistive element 5. Herein, the potential difference between both sides means a potential difference between conductive portions on both sides of each trimming groove. In a conventional resistor with two trimming grooves, the minimum value of the potential difference between the both sides was 176 V.

In FIG. 4, a line connecting points (A) indicates a potential difference between both sides of first trimming groove 16, and a line connecting points (O) indicates a potential difference between both sides of each of second trimming grooves 17. Straight line 61 indicates a voltage of 176 V which is the minimum value of a potential difference between both sides in a conventional resistor. As shown in FIG. 4, when the above ration is small (for example, around 0%), the potential difference between the both sides of first trimming groove 16 is 176 V or more. As the above ratio increases, the potential difference between the both sides of first trimming groove 16 decreases. When the ratio is 53% or more, the potential difference between the both sides becomes less than 176 V. When the ratio is small (for example, around 0%), the potential difference between the both sides of second trimming groove 17 is small. But, as the ratio increases, the potential difference between the both sides of second trimming groove 17 increases. However, even if the ratio approaches and exceeds 100%, when the ratio is 130% or less, the potential difference between the both sides of second trimming groove 17 is less than 176 V.

From the above, it is found that the ratio of 53% or more and 130% or less provides a potential difference that is even smaller than the conventional minimum potential difference between the both sides of the groove. Furthermore, the ratio preferably ranges from 70 to 120%, and even more preferably, from 80 to 110%. It is because these conditions allow the potential difference between both sides of each of all the trimming grooves to be lower than 150 V.

### Second Exemplary Embodiment

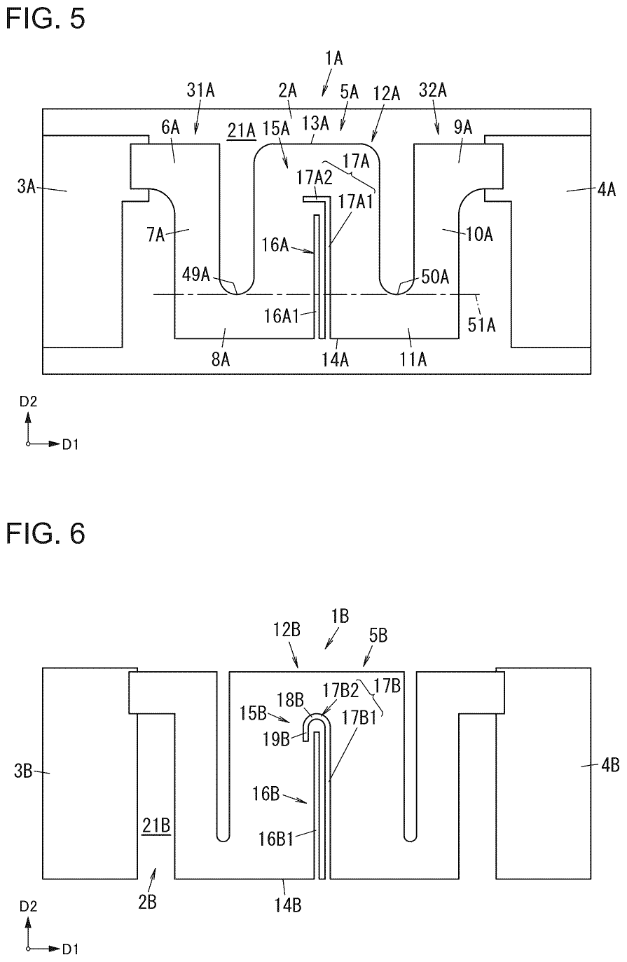

Chip resistor 1A according to a second exemplary embodiment will be described with reference to FIG. 5. The basic configuration of chip resistor 1A is the same as chip resistor 1 according to the first exemplary embodiment, and the following description focuses on the differences.

Meandering part 15A has two trimming grooves formed therein. Specifically, meandering part 15A includes first trimming groove 16A and second trimming groove 17A. First trimming groove 16A and second trimming groove 17A are arranged along the longitudinal direction D1 (an example of the first direction).

First trimming groove 16A includes first straight part 16A1 extending from second edge 14A of resistance value adjusting part 12A along the short direction D2.

Second trimming groove 17A includes second straight part 17A1 extending from second edge 14A of resistance value adjusting part 12A along the short direction D2 (an example of the second direction), and bent part 17A2 extending from the tip end of second straight part 17A1 in a direction approaching first trimming groove 16A.

The length of second straight part 17A1 of second trimming groove 17A in the short direction D2 is larger than the length of first trimming groove 16A of first trimming groove 16A in the short direction D2.

Bent part 17A2 of second trimming groove 17A is bent perpendicularly from a tip end of second straight part 17A1 and extends toward the second side in the longitudinal direction. A tip end of bent part 17A2 is located closer to second side in the longitudinal direction than a tip end of first straight part 16A1 of first trimming groove 16A.

The above configuration reduces the potential difference between both sides of each trimming groove in meandering part 15A, thus providing a meandering pattern that withstands a high potential difference.

### Third Exemplary Embodiment

Chip resistor 1B according to a third exemplary embodiment will be described with reference to FIG. 6. The basic configuration of chip resistor 1B is the same as chip resistor 1 according to the first exemplary embodiment, and the following description focuses on the differences.

Resistance value adjusting part 12B of resistive element 5B includes meandering part 15B. Meandering part 15B has a trimming groove for providing resistance value adjusting part 12B with a meandering shape. Specifically, meandering part 15B has first trimming groove 16B and second trimming groove 17B formed therein. First trimming groove 16B and second trimming groove 17B are arranged along the longitudinal direction D1 (an example of the first direction). First trimming groove 16B and second trimming groove 17B extend from second edge 14B (an example of the groove-starting edge) of resistance value adjusting part 12B in the short direction D2 (short direction). Second trimming groove 17B is disposed on the first side of first trimming groove 16B in the longitudinal direction.

First trimming groove 16B includes first straight part 16B1 extending from second edge 14B of resistance value adjusting part 12B toward a first side in the short direction.

Second trimming groove 17B includes second straight part 17B1 extending from second edge 14B of resistance value adjusting part 12B toward a first side in the short direction, and bent part 17B2 (an example of the folded part) extending toward first straight part 16B1 from a tip end of second straight part 17B1.

The length of second straight part 17B1 of second trimming groove 17B in the short direction D2 is larger than the length of first straight part 16B1 of first trimming groove 16B of first trimming groove 16B in the short direction D2.

Bent part 17B2 of second trimming groove 17B includes first section 18B that is semicircular in plan view in the thickness direction of insulating substrate 2B, and second section 19B folded back toward second straight part 17B1 and extends in parallel to second straight part 17B1.

Bent part 17B2 of second trimming groove 17B is opposite to second edge 14B with respect to the tip end of first straight part 16B1 of first trimming groove 16B. Specifically, first section 18B curves from the tip end of second straight part 17B1 so as to be convex outward in the short direction and extends to the second side in the longitudinal direction. More specifically, the tip end of bent part 17B2 (particularly, second section 19B) is closer to the second side in the short direction than the tip end of first straight part 16B1. In other words, the tip end section of first straight part 16B1 is surrounded on both sides in the longitudinal direction and on the first side in the short direction by second trimming groove 17B.

The above configuration reduces the potential difference between both sides of each trimming groove in meandering part 15, thus providing a meandering pattern that can withstand a high potential difference.

In the above configuration, since second trimming groove 17B includes bent part 17B2, microcracks are less likely produced in the most forward section of second trimming groove 17B in the extending direction. In particular, bent part 17B2 includes a circular arc part, and mitigates concentration of electric current on a corner at the tip end of the folded part, thus improving load characteristics of the resistor.

More specifically, since the microcracks at the tip end of second trimming groove 17B are oriented in the same direction as the current path, the resistance value hardly changes even when the microcracks grow. In other words, accuracy and reliability of the resistance value are improved. Furthermore, fluctuations of the resistance value at the time when the microcracks at the tip end of first trimming groove 16B grow can be reduced, accordingly enhancing accuracy and reliability of the resistance value.

Furthermore, since bent part 17B2 of second trimming groove 17B is bent toward first trimming groove 16B in the longitudinal direction D1, the microcracks produced at the tip end of second trimming groove 17B may be disposed in a position in which current hardly flows. As a result, accuracy and reliability of the resistance value are further enhanced.

### Fourth Exemplary Embodiment

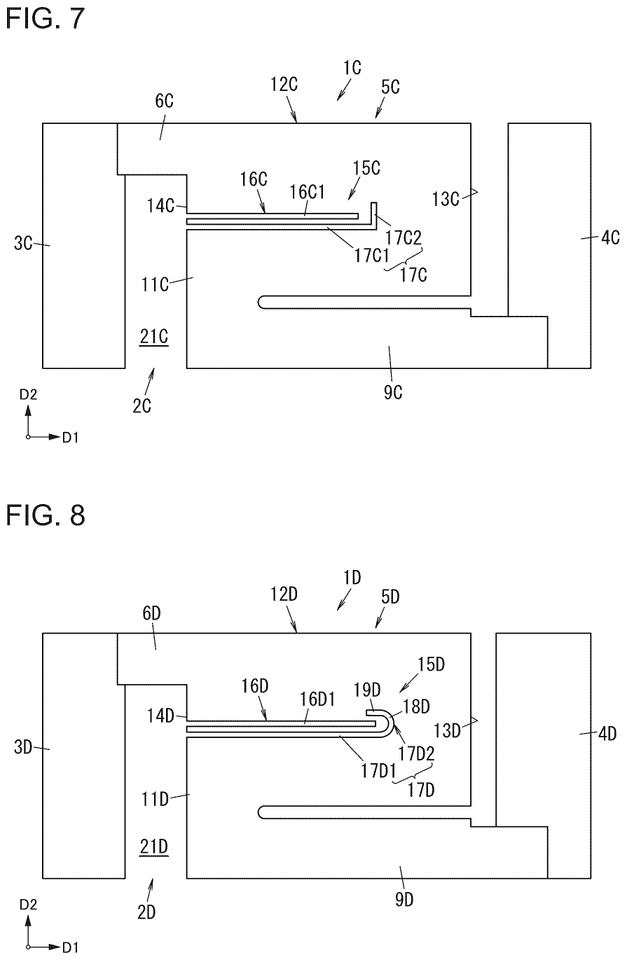

Chip resistor 1C according to a fourth exemplary embodiment will be described with reference to FIG. 7. The basic configuration of chip resistor 1C is the same as chip resistor 1 according to the first exemplary embodiment, and the following description focuses on the differences.

Resistive element 5C includes resistance value adjusting part 12C, first connection part 6C, and second connection part 9C.

Resistance value adjusting part 12C is disposed in the middle of surface 21C of insulating substrate 2C in longitudinal direction, that is, between first upper surface electrode 3C and second upper surface electrode 4C. Resistance value adjusting part 12C is a section for adjusting resistance value of resistive element 5C by laser trimming. An edge of resistance value adjusting part 12C at a first side in the longitudinal direction is first edge 13C at an edge of the first edge. An edge of resistance value adjusting part 12C at the second side in the longitudinal direction is second edge 14C (an example of the groove-starting edge).

First connection part 6C and second connection part 9C are arranged in the short direction D2 (an example of the first direction). First connection part 6C is connected to a first side of first upper surface electrode 3C in the short direction, and extends toward the first side of first upper surface electrode 3C in the longitudinal direction to be connected to resistance value adjusting part 12C. Second connection part 9C is connected to a second side section of second upper surface electrode 4 in the short direction, and extends toward the second side of second upper surface electrode 4 in the longitudinal direction. An edge of the second side of second connection part 9C in the longitudinal direction is coupled with resistance value adjusting part 12C via connection section 11C.

Resistive element 5C includes a meandering shape folded back in a direction parallel to the longitudinal direction D1 of insulating substrate 2C. Specifically, first connection part 6C and resistance value adjusting part 12C form the first turn folded back toward the second side in the longitudinal direction. Furthermore, resistance value adjusting part 12C, connection section 11C, and second connection part 9C form the second turn folded back to the first side in the longitudinal direction.

Resistance value adjusting part 12C includes meandering part 15C. Meandering part 15C has a trimming groove therein for providing resistance value adjusting part 12C with a meandering shape. Specifically, meandering part 15C has first trimming groove 16C and second trimming groove 17C formed therein. First trimming groove 16C and second trimming groove 17C extend from second edge 14C of resistance value adjusting part 12C in parallel to the longitudinal direction D1 (an example of the second direction). Second trimming groove 17C is disposed at the second side of first trimming groove 16C in the short direction.

First trimming groove 16C includes first straight part 16C1 extending from second edge 14C of resistance value adjusting part 12C toward the first side in the longitudinal direction.

Second trimming groove 17C includes second straight part 17C1 extending from second edge 14C of resistance value adjusting part 12C along the short direction D2, and bent part 17C2 extending from the tip end of second straight part 17C1 in a direction approaching first trimming groove 16A.

The length of second straight part 17C1 of second trimming groove 17C in the longitudinal direction D1 (an example of the second direction) is larger than the length of first straight part 1 6C1 as first trimming groove 16 of first trimming groove 16C in the longitudinal direction D1.

Bent part 17C2 of second trimming groove 17C is opposite to second edge 14C with respect to the tip of first straight part 16C1 of first trimming groove 16C. Specifically, bent part 17C2 is bent perpendicularly from a tip end of second straight part 17C1, and extends toward the second side in the longitudinal direction. A tip end of bent part 17C2 is closer to the first side in the short direction than a tip end of first straight part 16C1 of first trimming groove 16C.

The above configuration reduces the potential difference between both sides of each trimming groove in meandering part 15C, thereby providing a meandering pattern that can withstand a high potential difference.

### Fifth Exemplary Embodiment

Chip resistor 1D according to a fifth exemplary embodiment will be described with reference to FIG. 8. The basic configuration of chip resistor 1D is the same as chip resistor 1C according to the fourth exemplary embodiment, and the following description focuses on the differences.

Resistance value adjusting part 12D of resistive element 5D includes meandering part 15D. Meandering part 15D has a trimming groove for providing resistance value adjusting part 12D with a meandering shape. Specifically, meandering part 15D has first trimming groove 16D and second trimming groove 17D formed therein. First trimming groove 16D and second trimming groove 17D are arranged along the short direction D2. First trimming groove 16D and second trimming groove 17D extend in parallel to short direction D2 (an example of the first direction). Second trimming groove 17D is disposed at a second side of first trimming groove 16D in the short direction.

First trimming groove 16D includes first straight part 1 6D1 extending from second edge 14D of resistance value adjusting part 12D toward a first side in the longitudinal direction.

Second trimming groove 17D includes second straight part 17D1 extending from second edge 14D of resistance value adjusting part 12D toward a first side in the longitudinal direction, and bent part 17D2 (an example of the folded part) extending from a tip end of second straight part 17D1 toward first straight part 16D1. Bent part 17D2 includes first section 18D that is semicircular in plan view in the thickness direction of insulating substrate 2D, and second section 19D folded back to second straight part 17D1 and extending in parallel to second straight part 17D1.

The length of second straight part 17D1 of second trimming groove 17D in the longitudinal direction D1 is larger than the length of first straight part 16D1 of first trimming groove 16D of first trimming groove 16D in the longitudinal direction D1.

Bent part 17D2 of second trimming groove 17D is opposite to second edge 14D with respect to the tip end of first straight part 16D1 of first trimming groove 16D. Specifically, first section 18D curves from the tip end of second straight part 17D1 so as to be convex outward in the longitudinal direction, and extends toward the second side in the longitudinal direction. In more detail, the tip end of bent part 17D2 (particularly, second section 19D) is located closer to the second side in the longitudinal direction than the tip end of first straight part 16D1. That is to say, in the tip end section of first straight part 16D1, both sides of first straight part 16D1 in the short direction and a first side of first straight part 16D1 in the longitudinal direction are surrounded by second trimming groove 17D.

The above configuration reduces the potential difference between both sides of each trimming groove in meandering part 15D, thereby providing a meandering pattern that can withstand a high potential difference.

### Modification

The above-described exemplary embodiments are merely one of various exemplary embodiments of the present disclosure. The above-described exemplary embodiments can be modified in various ways depending on the design and the like as long as the object of the present disclosure can be achieved. Hereinafter, modifications of the above-described exemplary embodiments are listed. The modifications described below can be applied in appropriate combinations.

Chip resistor 1 may be a thin film chip resistor.

In accordance with the first to fifth exemplary embodiments, the length of the second straight part of the second trimming groove is larger than the length of first straight part of the first trimming groove. However, the length of the second straight part of the second trimming groove may be smaller than the length of the first straight part of the first trimming groove.

Shape or length of the bent part of the trimming groove are not particularly limited. However, the folded part may preferably curve smoothly without an edge.

In accordance with the first to fifth exemplary embodiments, the bent part of the second trimming groove overlaps the first straight part of the first trimming groove and extends beyond the first straight part of the first trimming groove when viewed in the direction in which the grooves are arranged. However, the bent part of the second trimming groove may not necessarily overlap the first straight part of the first trimming groove when viewed in the direction in which the grooves are arranged, or may overlap only a part of the first straight part of the first trimming groove in the direction in which the grooves are arranged.

### Aspects

The present specification discloses the following aspects.

The chip resistor (1, 1A, 1B, 1C, 1D) according to the first aspect includes a substrate (2, 2B, 2C, 2D), a pair of electrodes (3, 3C, 4, 4C), and a resistive element (5, 5B, 5C, 5D). The pair of electrodes (3, 4) are provided on both ends of one surface (21, 21C) of the substrate (2, 2B, 2C, 2D). The resistive element (5, 5B, 5C, 5D) is provided on the one surface (21, 21C) of the substrate (2, 2B, 2C, 2D) between the pair of electrodes (3, 3C, 4, 4C). The resistive element includes a pair of connection parts (31, 32) connected to the pair of electrodes (3, 4), respectively, and a resistance value adjusting part (12, 12A, 12B, 12C, 12D) provided between the pair of connection parts (31, 32). The resistance value adjusting part (12, 12A, 12B, 12C, 12D) includes a meandering part (15, 1, 15B, 15C, 15D) providing the resistance value adjusting part (12, 12A, 12B, 12C, 12D) with a meandering shape. The meandering part (15, 15A, 15B, 15C, 15D) has a first trimming groove (16, 16A, 16B, 16C, 16D) and a second trimming groove (17, 17A, 17B, 17C, 17D) formed therein. The first trimming groove (16, 16A, 16B, 16C, 16D) and the second trimming groove (17, 17A, 17B, 17C, 17D) are arranged along a first direction in which the pair of connecting parts (31, 32) are arranged. The first trimming groove (16, 16A, 16B, 16C, 16D) includes a first straight part (161, 16A1, 16B1, 16C1, 16D1) extending from a groove-starting edge (14, 14A, 14B, 14C, 14D) of the resistance value adjusting part (12, 12A, 12B, 12C, 12D) in a second direction perpendicular to the first direction. The second trimming groove (17, 17A, 17B, 17C, 17D) includes a second straight part (17P1, 17A1, 17B1, 17C1, 17D1) extending from the groove-starting edge (14, 14A, 14B, 14C, 14D) of the resistance value adjusting part (12, 12A, 12B, 12C, 12D) in the second direction, and a bent part (17P2, 17A2, 17B2, 17C2, 17D2) extending from the tip of the second straight part (17P1, 17A1, 17B1, 17C1, 17D1) in a direction approaching the first trimming groove (16, 16A, 16B, 16C, 16D).

This aspect reduces the potential difference between both sides of each trimming groove in the meandering part, thus providing a meandering pattern that can withstand a high potential difference.

In the chip resistor (1, 1A, 1B, 1C, 1D) according to the second aspect, in the first aspect, a length of the second straight part (17P1, 17A1, 17B1, 17C1, 17D1) in the second direction is larger than a length of the first straight part (16P1, 16A1, 16B1, 16C1, 16D1) in the second direction.

This aspect reduces the potential difference between both sides of each trimming groove in the meandering part, thus providing a meandering pattern that can withstand a high potential difference.

In the chip resistor (1, 1A, 1B, 1C, 1D) according to the third aspect, in the first or second aspect, the bent part (17P2, 17A2, 17B2, 17C2, 17D2) of the second trimming groove (17, 17A, 17B, 17C, 17D) is opposite to the groove-starting edge (14, 14A, 14B, 14C, 14D) with respect to the tip end of the first straight part (16P1, 16A1, 16B1, 16C1, 16D1) of the first trimming groove (16, 16A, 16B, 16C, 16D).

This aspect reduces the potential difference between both sides of each trimming groove in the meandering part, thus providing a meandering pattern that can withstand a high potential difference.

In the chip resistor (1, 1B, 1D) according to the fourth aspect, in any of the first to third aspects, the bent part (17P2, 17B2, 17D2) includes a folded part (17P2, 17B2, 17D2) that extends so as to be folded back to the second straight part (17P1, 17A1, 17B1, 17C1, 17D1).

This aspect can reduce the potential difference between both sides of each trimming groove in the meandering part, thus providing a meandering pattern that can withstand a high potential difference.

In the chip resistor (1B, 1D) according to the fifth aspect, in the fourth aspect, the folded part (17B2, 17D2) of the second trimming groove (17B, 17D) includes a circular arc part.

In this aspect, the folded part includes a circular arc part allows microcracks to be less likely produced at the most forward section of the trimming groove in the extending direction.

In the chip resistor (1) according to the sixth aspect, in the first to fifth aspects, each of the pair of connection parts (31, 32) includes a connection section (8, 11) provided in a vicinity of the groove-starting edge of the resistance value adjusting part and connected to the resistance value adjusting part. The relations, a1/b1>0.53 and a1/b1≤1.30 are satisfied where a1 is a length of the second trimming groove (17) from the edge (49, 50) of the connection section (8, 11) opposite to the groove-starting edge (14) to the tip of the second trimming groove (17), and b1 is a length of the first trimming groove (16) from the edge (14) of the connection section (8, 11) to the tip of the first trimming groove (16).

This aspect reduces the potential difference between both sides of each trimming groove as compared with a conventional example of two trimming grooves, and is less likely that voltage breakdown occurs in a groove section, and therefore characteristic abnormality can be suppressed.

### Sixth Exemplary Embodiment

### (6-1) Basic Configuration of Chip Resistor

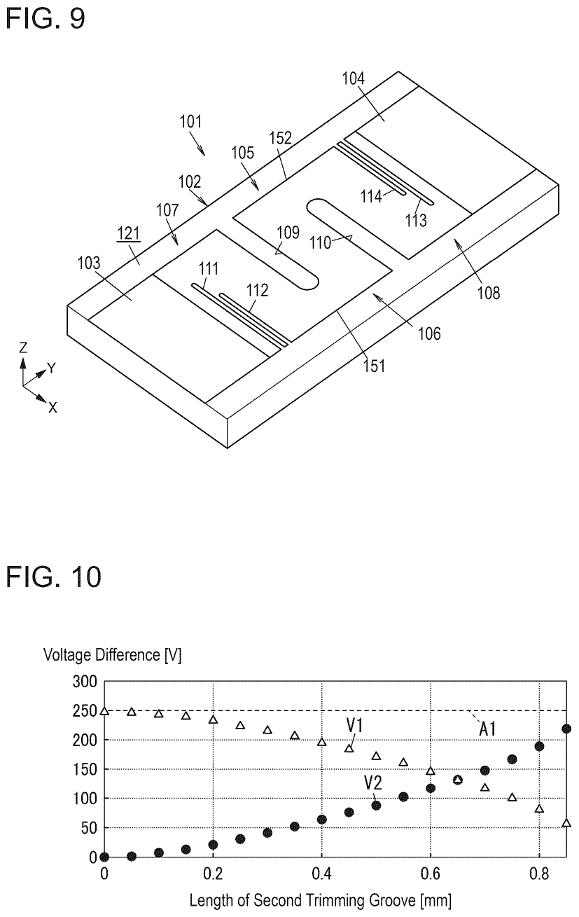

A sixth exemplary embodiment will be described below with reference to FIG. 9.

Chip resistor 101 is, for example, a chip resistor for Surface Mount Technology (SMT), which is to be mounted on a surface (mount surface) of a printed circuit board, by using a surface mounting machine (mounter). In this exemplary embodiment, an example of chip resistor 101 is a thick-film chip resistor.

As shown in FIG. 9, chip resistor 101 includes insulating substrate 102, first upper surface electrode 103, second upper surface electrode 104, and resistive element 105. Chip resistor 101 further includes a first lower surface electrode, a second lower surface electrode, a first end surface electrode, a second end surface electrode, a pair of first plating layers, and a pair of second plating layers although not shown. Chip resistor 101 further includes a glass protective film and a resin protective film although not shown.

### (6-2) Insulating Substrate

Insulating substrate 102 is made of, for example, alumina containing 96% Al₂O₃, and has a rectangular shape (rectangular when viewed from above). In insulating substrate 102, the longitudinal direction is along the Y-axis direction (first direction), the short direction is along an X-axis direction (second direction), and a thickness direction is along a Z-axis direction. Furthermore, the diagonally upper right side in FIG. 9 is the first side in the longitudinal direction (the first side in the Y-axis direction), the diagonally lower left side in FIG. 9 is the second side in the longitudinal direction (the second side in the Y-axis direction), the diagonally upper left side of FIG. 9 is the first side in the short direction (the first side in the X-axis direction), and the diagonally lower right side of FIG. 9 is the second side in the short direction (the second side in the X-axis direction).

Note here that the X-axis, Y-axis, and Z-axis directions are perpendicular to one another, but the concept of “perpendicular” in this case includes “approximately perpendicular,” and includes the range of 90°±10°.

### (6-3) Upper Surface Electrode

First upper surface electrode 103 and second upper surface electrode 104 are provided on both end parts of surface 121 of insulating substrate 102 in the longitudinal direction, respectively, and are formed by printing and firing a thick-film material containing metal such as silver.

### (6-4) Resistive Element

### (6-4-1) Overview of Resistive Element

Resistive element 105 is formed on surface 211 (one surface) of insulating substrate 102 between first upper surface electrode 103 and second upper surface electrode 104, and is connected to first upper surface electrode 103 and second upper surface electrode 104. Resistive element 105 is formed by, for example, printing a thick film material made of about 10 wt % lead ruthenate, about 53 wt % glass, and about 37 wt % solvent on surface 121 of insulating substrate 102, and then baking the printed material. Resistive element 105 has first edge 151 and second edge 152 extending in the Y-axis direction. First edge 151 is close to the second side in the Y-axis direction, and second edge 152 is close to the first side in the Y-axis direction.

Resistive element 105 includes meandering part 106, first rectangular part 107, and second rectangular part 108.

Meandering part 106 is disposed at the center of surface 121 of insulating substrate 102 in the longitudinal direction, that is, between first upper surface electrode 103 and second upper surface electrode 104. Meandering part 106 has first recess 109 and second recess 110 formed therein. In the Y-axis direction, first recess 109 is disposed closer to first upper surface electrode 103, and second recess 110 is disposed closer to second upper surface electrode 104. First recess 109 extends in the X-axis direction from second edge 152 of resistive element 105 on the first side in the X-axis direction, and second recess 110 extends in the X-axis direction from first edge 151 of resistive element 105 on the second side in the X-axis direction. As a result, meandering part 106 has a two-folded meandering shape (an S-shape).

First rectangular part 107 continuously extends from meandering part 106, and is connected to first upper surface electrode 103.

Second rectangular part 108 continuously extends from meandering part 106, and is connected to second upper surface electrode 104.

### (6-4-2) Rectangular Part

### (6-4-2-1) First Rectangular Part

First rectangular part 107 has first trimming groove 111 and second trimming groove 112 formed therein. First trimming groove 111 and second trimming groove 112 extend straight in parallel along the X-axis direction from first edge 151 of first rectangular part 107. First trimming groove 111 and second trimming groove 112 provide first rectangular part 107 with a meandering shape. First trimming groove 111 and second trimming groove 112 are formed in first rectangular part 107 in the vicinity of first upper surface electrode 103 (a region closer to first upper surface electrode 103 than the center in the Y-axis direction in first rectangular part 107).

First trimming groove 111 is closer to first upper surface electrode 103 than second trimming groove 112 in the Y-axis direction.

The length of first trimming groove 111 is larger than the length of second trimming groove 112. In other words, the tip end of first trimming groove 111 is closer to second edge 152 than the tip end of second trimming groove 112.

### (6-4-2-2) Second Rectangular Part

Second rectangular part 108 has third trimming groove 113 and fourth trimming groove 114 formed therein. Third trimming groove 113 and fourth trimming groove 114 extend parallel to each other along the X-axis direction straight from second edge 152 of second rectangular part 108. Second rectangular part 108 has a meandering shape due to third trimming groove 113 and fourth trimming groove 114. Third trimming groove 113 and fourth trimming groove 114 are formed in second rectangular part 108 in a vicinity of second upper surface electrode 104 (in a region closer to second upper surface electrode 104 than the center of the second rectangular part 108 in the Y-axis direction).

Third trimming groove 113 is closer to second upper surface electrode 104 than fourth trimming groove 114 in the Y-axis direction.

The length of third trimming groove 113 is larger than the length of fourth trimming groove 114. In other words, the tip end of third trimming groove 113 is closer to first edge 151 than the tip end of fourth trimming groove 114.

### (6-5) Advantageous Effect

Advantageous effect of chip resistor 101 will be described below with reference to FIG. 10.

FIG. 10 shows the simulation results of the potential difference between both sides of ends of each of first trimming groove 111 and second trimming groove 112 when, for example, the length of first trimming groove 111 is fixed to 0.85 mm and the length of second trimming groove 112 that serves as a second one of the trimming grooves is changed within a range from 0 to 0.85 mm. In FIG. 10, A1 represents the potential difference (250 V) when simulating the conventional resistor where only one trimming groove is formed, V1 represents the potential difference at first trimming groove 111, and V2 represents the potential difference at second trimming groove 112.

As shown in FIG. 10, when the length of second trimming groove 112 exceeds 0 mm, the potential difference is smaller than in the conventional resistor having a single groove therein. Furthermore, when the length of second trimming groove 112 is less than 0.85 mm, the potential difference applied to both sides of ends of each trimming grooves is smaller than the resistor having the grooves with the same length. Therefore, even when chip resistor 101 is used at high voltage, insulation breakdown is less likely to occur in the trimming groove, and as a result, characteristic abnormality is less likely to occur.

In particular, in FIG. 10, when the length of second trimming groove 112 is 0.65 mm, the potential difference at each of first trimming groove 111 and second trimming groove 112 is 134 V, thus meaning that the larger of the potential differences at the two trimming grooves is the minimum value. The potential difference between both sides of each trimming groove in the rectangular part is significantly reduced compared with the resistor having a single trimming groove, thus providing a meandering pattern that can withstand a high potential difference.

The optimal value of the length of second trimming groove 112 varies depending on the shape of the resistive element, the positions or lengths of first trimming groove 111 and second trimming groove 112.

The surface of a resistor is often covered with a resin-based or glass-based protective film, and the insulating pressure-resistance of the trimming groove is approximately 1 kV/mm. Since the width of the trimming groove ranges approximately from 0.015 to 0.040 mm, the withstand voltage of the protective film in the trimming groove ranges from 150 to 400 V. Therefore, even with a potential difference of 250 V, as shown in the simulation in the resistor having a single trimming groove, insulation breakdown may occur. However, two trimming grooves are formed with appropriate lengths as in this embodiment, the potential difference is 134 V, which is not higher than the withstand voltage of the protective film.

In accordance with this exemplary embodiment, the trimming grooves are formed in both first rectangular part 107 and second rectangular part 108. This configuration allows the resistance value to be adjusted in the vicinity of first upper surface electrode 103 and second upper surface electrode 104 on both sides, thus expanding the adjustable range of the resistance value and enhancing the accuracy of the resistance value adjustment.

### (6-6) Method of Manufacturing Chip Resistor

A method of manufacturing chip resistor 101 will be described below. For simplifying the description, only the formation of first upper surface electrode 103, second upper surface electrode 104, and resistive element 105 will be described.

First, electrode paste is screen-printed on both end parts of insulating substrate 102 made of alumina in the longitudinal direction, and then, fired at 850° C. to form first upper surface electrode 103 and second upper surface electrode 104.

Next, a resistive paste is screen-printed between first upper surface electrode 103 and second upper surface electrode 104, and then, fired at 850° C. to form resistive element 105. Resistive element 105 includes meandering part 106, first rectangular part 107, and second rectangular part 108. Finally, first trimming groove 111 and second trimming groove 112 are formed in first rectangular part 107 by laser processing, and third trimming groove 113 and fourth trimming groove 114 are formed in second rectangular part 108. The order of formation of first upper surface electrode 103 and second upper surface electrode 104 and formation of resistive element 105 may be reversed.

### Seventh Exemplary Embodiment

In the sixth exemplary embodiment described above, the trimming grooves have straight shapes, but the shapes of the trimming grooves are not particularly limited.

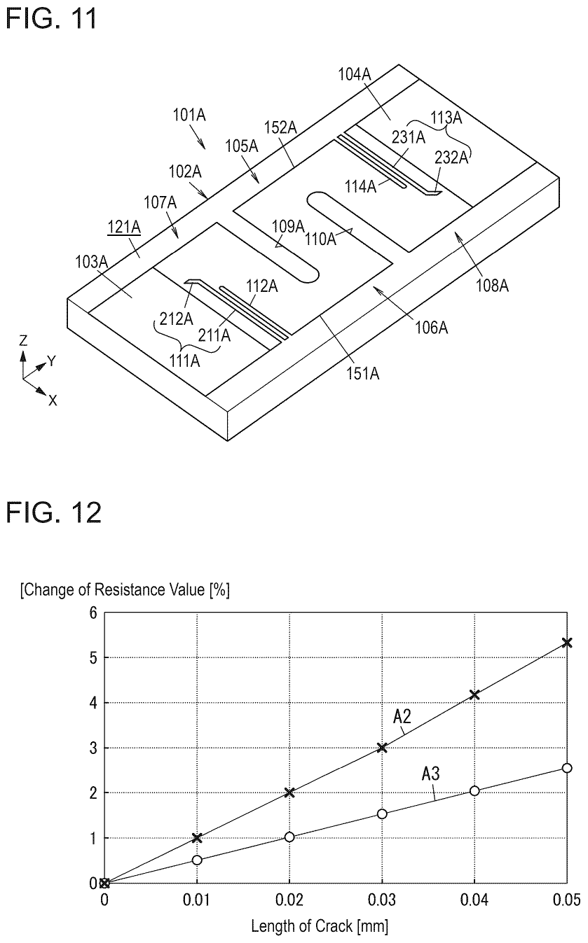

Chip resistor 101A having a trimming groove with different shapes from that the sixth exemplary embodiment will be described as a seventh exemplary embodiment with reference to FIGS. 11 and 12. The basic configuration of chip resistor 101A is the same as chip resistor 101 according to the sixth exemplary embodiment, and the following description focuses on the differences.

### (7-1) Overview of Chip Resistor

As shown in FIG. 11, chip resistor 101A includes insulating substrate 102A, first upper surface electrode 103A, second upper surface electrode 104A, and resistive element 105A.

### (7-2) Insulating Substrate

Insulating substrate 102A is made of, for example, alumina containing 96% Al₂O₃, and has a rectangular shape (rectangular when viewed from above). The longitudinal direction of insulating substrate 102A is along the Y-axis, the short direction is along the X-axis, and the thickness direction is along the Z-axis.

### (7-3) Upper Surface Electrode

First upper surface electrode 103A and second upper surface electrode 104A are provided on both end parts of surface 121A of insulating substrate 102A in the longitudinal direction, respectively, and are formed by printing and firing thick-film material containing metal, such as silver.

### (7-4) Resistive Element

### (7-4-1) Overview of Resistive Element

Resistive element 105A is formed on surface 121A of insulating substrate 102A between first upper surface electrode 103A and second upper surface electrode 104A, and is connected to first upper surface electrode 103A and second upper surface electrode 104A. Resistive element 105A has first edge 151A and second edge 152A extending in the Y-axis direction. First edge 151A is closer to second side in the X-axis direction, and second edge 152A is closer to a first side in the X-axis direction.

Resistive element 105A includes meandering part 106A, first rectangular part 107A, and second rectangular part 108A.

Meandering part 106A is disposed in the middle of surface 121A of insulating substrate 102A in the longitudinal direction, that is, between first upper surface electrode 103A and second upper surface electrode 104A. Meandering part 106A has first recess 109A and second recess 110A formed therein. In the Y-axis direction, first recess 109A is closer to first upper surface electrode 103A, and second recess 110 is closer to second upper surface electrode 104A. First recess 109A extends in the X-axis direction from second edge 152A of resistive element 105A on the first side in the X-axis direction, and second recess 110A extends in the X-axis direction from first edge 151A of resistive element 105A on the second side in the X-axis direction. Meandering part 106A thus has a meandering shape folded twice (approximately, an S-shape).

First rectangular part 107A continuously extends from meandering part 106A and is connected to first upper surface electrode 103A.

Second rectangular part 108A continuously extends from meandering part 106A and is connected to second upper surface electrode 104A.

### (7-4-2) Rectangular Part

### (7-4-2-1) First Rectangular Part

First rectangular part 107A has first trimming groove 111A and second trimming groove 112A formed therein. First trimming groove 111A and second trimming groove 112A extend from first edge 151A of first rectangular part 107A substantially parallel to each other in the X-axis direction. First trimming groove 111A and second trimming groove 112A provide first rectangular part 107A with a meandering shape. First trimming groove 111A and second trimming groove 112A are formed in the vicinity of first upper surface electrode 103A in first rectangular part 107A (in a region closer to first upper surface electrode 103A than the center in the Y-axis direction of first rectangular part 107).

First trimming groove 111A is closer to first upper surface electrode 103A than second trimming groove 112A in the Y-axis direction.

The length of first trimming groove 111A is larger than the length of second trimming groove 112A. That is to say, the tip end of first trimming groove 111A is closer to the tip end of second edge 152A than the tip end of second trimming groove 112A.

First trimming groove 111A includes straight part 211A and tip end part 212A extending from the tip end of straight part 211A toward the tip end of first upper surface electrode 103. Specifically, tip end part 212A has a straight shape, and inclines toward first upper surface electrode 103A from straight part 211A. The inclination angle of tip end part 212A with respect to straight part 211A ranges from 30 to 60 degrees.

Second trimming groove 112A has a straight shape.

### (7-4-2-2) Second Rectangular Part

Second rectangular part 108A has third trimming groove 113A and fourth trimming groove 114A formed therein. Third trimming groove 113A and fourth trimming groove 114A extend substantially in parallel to each other from second edge 152A of second rectangular part 108A along the X-axis direction. Third trimming groove 113A and fourth trimming groove 114A provide second rectangular part 108A with a meandering shape. Third trimming groove 113A and fourth trimming groove 114A are formed in second rectangular part 108A in the vicinity of second upper surface electrode 104A (in a region closer to second upper surface electrode 104A than the center of second rectangular part 108A in the Y-axis direction).

Third trimming groove 113A is closer to second upper surface electrode 104A than fourth trimming groove 114A in the Y-axis direction.

The length of third trimming groove 113A is larger than the length of fourth trimming groove 114A. That is to say, the tip end of third trimming groove 113A is closer to first edge 151A than the tip end of fourth trimming groove 114A.

Third trimming groove 113A includes straight part 231A and tip end part 232A extending from the tip end of straight part 231A toward second upper surface electrode 104. Specifically, tip end part 232A has a straight shape, and inclines from straight part 231A toward second upper surface electrode 104A. The inclination angle of tip end part 232A with respect to straight part 231A ranges from 30 to 60 degrees.

Fourth trimming groove 114A has a straight shape.

### (7-5) Advantageous Effect

(7-5-1)

In accordance with the seventh exemplary embodiment, as in the sixth exemplary embodiment, the potential difference between both sides of each trimming groove in the rectangular part is significantly reduced as compared with the resistor having a single trimming groove, thus providing a meandering pattern that can withstand a high potential difference.

(7-5-2)

In particular in the seventh exemplary embodiment, tip end part 212A and tip end part 232A of straight part 211A and straight part 231A reduce current concentration on the tip of each of the trimming grooves. As a result, characteristic abnormality due to overload can be suppressed.

(7-5-3)

In general, laser trimming is likely to produce microcracks in the travelling direction of the laser trimming, and therefore, variations occur in resistance value. However, in accordance with the seventh exemplary embodiment, tip end part 212A and tip end part 232A suppress the rate of change of resistance value due to microcracks, so that a resistance value variation rate of the product can be reduced.

FIG. 12 shows a change of the resistance value variation rate with respect to the crack length. In FIG. 12, A2 represents an example of this exemplary embodiment in which an inclining tip end part is not provided in the trimming groove, and A3 represents an example of this exemplary embodiment in which an inclining tip end part is provided in the trimming groove. As shown in FIG. 12, The inclining tip end part reduces the resistance value variation rate with respect to the length of the microcrack.

### Eighth Exemplary Embodiment

In accordance with the sixth and seventh exemplary embodiments described above, two trimming grooves are formed in one rectangular part, but the number of trimming grooves may be two or more.

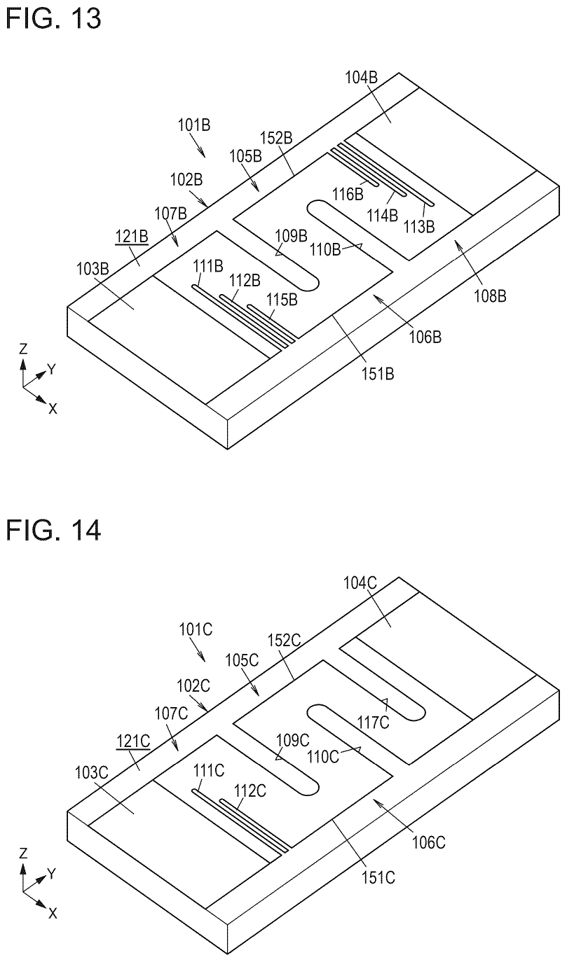

Chip resistor 101B having three trimming grooves formed therein will be described as an eighth exemplary embodiment with reference to FIG. 13. The basic configuration of chip resistor 101B is the same as chip resistor 101 according to the sixth exemplary embodiment, and the following description focuses on the differences.

### (8-1) Overview of Chip Resistor

As shown in FIG. 13, chip resistor 101B includes insulating substrate 102B, first upper surface electrode 103B, second upper surface electrode 104B, and resistive element 105B.

### (8-2) Insulating Substrate

Insulating substrate 102B is made of, for example, alumina containing 96% Al₂O₃, and has a rectangular shape (rectangular when viewed from above). The longitudinal direction of insulating substrate 102B is along the Y-axis, the short direction is along the X-axis direction, and the thickness direction is along the Z-axis direction.

### (8-3) Upper Surface Electrode

First upper surface electrode 103B and second upper surface electrode 104B are provided on both end parts of surface 121B of insulating substrate 102B in the longitudinal direction, respectively, and are formed by printing and firing a thick-film material containing metal, such as silver.

### (8-4) Resistive Element

### (8-4-1) Overview of Resistive Element

Resistive element 105B is formed on surface 121B of insulating substrate 102B between first upper surface electrode 103B and second upper surface electrode 104B, and is connected to first upper surface electrode 103B and second upper surface electrode 104B. Resistive element 105B has first edge 151B and second edge 152B extending in the Y-axis direction. First edge 151B is closer to the second side in the X-axis direction, and second edge 152B is closer to the first side in the X-axis direction.

Resistive element 105B includes meandering part 106B, first rectangular part 107B, and second rectangular part 108B.

Meandering part 106B is disposed on the middle of surface 121B of insulating substrate 102B in the longitudinal direction, that is, between first upper surface electrode 103B and second upper surface electrode 104B. Meandering part 106B has first recess 109B and second recess 110B formed therein. In the Y-axis direction, first recess 109B is closer to first upper surface electrode 103B, and second recess 110B is closer to second upper surface electrode 104B. First recess 109B extends in the X-axis direction from second edge 152B of resistive element 105B on the first side in the X-axis direction, and second recess 110B extends in the X-axis direction from first edge 151B of resistive element 105B on the second side in the X-axis direction. As a result, meandering part 106B has a two-folded meandering shape (approximately S-shaped).

First rectangular part 107B continuously extends from meandering part 106B, and is connected to first upper surface electrode 103B.

Second rectangular part 108B continuously extends from meandering part 106B, and is connected to second upper surface electrode 104B.

### (8-4-2) Rectangular Part

### (8-4-2-1) First Rectangular Part

First rectangular part 107B has first trimming groove 111B, second trimming groove 112B, and fifth trimming groove 115B formed therein. First trimming groove 111B, second trimming groove 112B, and fifth trimming groove 115B extend straight from first edge 151B of first rectangular part 107B in parallel to the X-axis direction. First trimming groove 111B, second trimming groove 112B, and fifth trimming groove 115B provides first rectangular part 107B with a meandering shape. First trimming groove 111B, second trimming groove 112B, and fifth trimming groove 115B are arranged in this order from a second side in the Y-axis direction toward the first side in the Y-axis direction. First trimming groove 111B, second trimming groove 112B, and fifth trimming groove 115B are formed in first rectangular part 107B in the vicinity of first upper surface electrode 103B (a region closer to first upper surface electrode 103B than the center in the Y-axis direction of first rectangular part 107).

First trimming groove 111B is closer to first upper surface electrode 103B than second trimming groove 112B in the Y-axis direction.

The length of first trimming groove 111B is larger than the length of second trimming groove 112B. In other words, the tip end of first trimming groove 111B is closer to second edge 152B than the tip end of second trimming groove 112B.

Fifth trimming groove 115B is opposite to second edge first trimming groove 111B of second trimming groove 112B. The length of fifth trimming groove 115B is smaller than the length of second trimming groove 112B. As a result, first rectangular part 107B has three trimming grooves therein which are longer as being closer to first upper surface electrode 103B.

### (8-4-2-2) Second Rectangular Part

Second rectangular part 108B has third trimming groove 113B, fourth trimming groove 114B, and sixth trimming groove 116B therein. Third trimming groove 113B, fourth trimming groove 114B, and sixth trimming groove 116B arranged in this order from a first side in the Y-axis direction toward the second side in the Y-axis direction. Third trimming groove 113B, fourth trimming groove 114B, and sixth trimming groove 116B extend straight in parallel to the X-axis direction from second edge 152B of second rectangular part 108B. Third trimming groove 113B, fourth trimming groove 114B, and sixth trimming groove 116B provide second rectangular part 108B with a meandering shape. Third trimming groove 113B, fourth trimming groove 114B, and sixth trimming groove 116B are formed in second rectangular part 108B in a vicinity of second upper surface electrode 104B (a region closer to second upper surface electrode 104B than the center in the Y-axis direction of the second rectangular part 108B).

Third trimming groove 113B is closer to second upper surface electrode 104B than fourth trimming groove 114B in the Y-axis direction.

The length of third trimming groove 113B is larger than the length of fourth trimming groove 114B.

Sixth trimming groove 116B is opposite to second trimming groove 112B of fourth trimming groove 114B. The length of sixth trimming groove 116B is smaller than the length of fourth trimming groove 114B. As a result, second rectangular part 108B has three trimming grooves therein which are longer as being closer to second upper surface electrode 104B.

### (8-5) Advantageous Effect

(8-5-1)

In accordance with the eighth exemplary embodiment, as in the sixth exemplary embodiment, the potential difference between both sides of each trimming groove in the rectangular part is significantly reduced as compared with the resistor having a single trimming groove, thus providing a meandering pattern that can withstand a high potential difference.

(8-5-2)

In particular, in the eighth exemplary embodiment, as described above, three trimming grooves are longer as being closer to the electrode as described above, and therefore, the potential difference between both sides of the trimming groove is further dispersed and reduced.

### (8-6) Modification of Eighth Exemplary Embodiment

The tip end part as in the seventh exemplary embodiment may be formed at tip ends of first trimming groove 111B and third trimming groove 113B.

### Ninth Exemplary Embodiment

In the sixth to eighth exemplary embodiments, the trimming grooves are formed in both rectangular parts, but the trimming groove may be formed in only one of the rectangular parts.

Chip resistor 101C in which a trimming groove is formed in only one rectangular part will be described as a ninth exemplary embodiment with reference to FIG. 14. The basic configuration of chip resistor 101C is the same as chip resistor 101 according to the sixth exemplary embodiment, and the following description focuses on the differences.

### (9-1) Overview of Chip Resistor

As shown in FIG. 14, chip resistor 101C includes insulating substrate 102C, first upper surface electrode 103C, second upper surface electrode 104C, and resistive element 105C.

### (9-2) Insulating Substrate

Insulating substrate 102C is made of, for example, alumina containing 96% Al₂O₃, and has a rectangular shape (rectangular when viewed from above). In insulating substrate 102C, the longitudinal direction is along the Y-axis, the short direction is along the X-axis direction, and the thickness direction is along the Z-axis direction.

### (9-3) Upper Surface Electrode

First upper surface electrode 103C and second upper surface electrode 104C are provided on both end parts in the longitudinal direction of surface 121C of insulating substrate 102C, respectively, and are formed by printing and firing a thick-film material containing metal, such as silver.

### (9-4) Resistive Element

### (9-4-1) Overview of Resistive Element

Resistive element 105C is formed on surface 121C of insulating substrate 102C between first upper surface electrode 103C and second upper surface electrode 104C, and is connected to first upper surface electrode 103C and second upper surface electrode 104C. Resistive element 105C has first edge 151C and second edge 152C extending in the Y-axis direction. First edge 151C is provided on the second side in the X-axis direction, and second edge 152C is provided on the first side in the X-axis direction.

Resistive element 105C includes meandering part 106C and rectangular part 107C.

Meandering part 106C is disposed on the center of surface 121C of insulating substrate 102C in the longitudinal direction, that is, between first upper surface electrode 103C and second upper surface electrode 104C. Meandering part 106C has first recess 109C, second recess 110C, and third recess 117C formed therein. First recess 109C, second recess 110C, and third recess 117C are arranged in this order from the second side in the Y-axis direction toward the first side in the Y-axis direction. In the Y-axis direction, first recess 109C is closer to first upper surface electrode 103B, and third recess 117C is closer to second upper surface electrode 104C, and second recess 110C is disposed between first recess 109C and third recess 117C. First recess 109C extends in the X-axis direction from second edge 152C of resistive element 105C on the first side in the X-axis direction. Second recess 110C extends in the X-axis direction from first edge 151C of resistive element 105C on a second side in the X-axis direction. Third recess 117C extends in the X-axis direction from second edge 152C of resistive element 105C on the first side in the X-axis direction. Meandering part 106C thus has a meandering shape folded back three times.

Rectangular part 107C continuously extends from meandering part 106C, and is connected to first upper surface electrode 103C.

### (9-4-2) Rectangular Part

Rectangular part 107C has first trimming groove 111C and second trimming groove 112C formed therein. First trimming groove 111C and second trimming groove 112C extend straight in parallel to the X-axis direction from first edge 151C of rectangular part 107C. First trimming groove 111C and second trimming groove 112C provide rectangular part 107C with a meandering shape. First trimming groove 111C and second trimming groove 112C are formed inside rectangular part 107C in the vicinity of first upper surface electrode 103C (a region closer to first upper surface electrode 103C than the center in the Y-axis direction in first rectangular part 107).

First trimming groove 111C is closer to first upper surface electrode 103C than second trimming groove 112C in the Y-axis direction.

The length of first trimming groove 111C is larger than the length of second trimming groove 112C. In other words, the tip end of first trimming groove 111C is closer to second edge 152C than the tip end of second trimming groove 112C.

### (9-5) Advantageous Effect

In accordance with the ninth exemplary embodiment, as in the sixth exemplary embodiment, the potential difference between both sides of each trimming groove in the rectangular part is significantly reduced as compared with the resistor having a single trimming groove, thus providing a meandering pattern that can withstand a high potential difference.

### (9-6) Modification of Ninth Exemplary Embodiment

The tip end part as in the seventh exemplary embodiment may be formed on a tip end of first trimming groove 111B and third trimming groove 113B.

The number of trimming grooves formed in the rectangular part may be three as in the eighth exemplary embodiment.

### Modification

The above-described exemplary embodiments are merely one of various exemplary embodiments of the present disclosure. The above-described exemplary embodiments can be modified in various ways depending on the design and the like as long as the object of the present disclosure can be achieved. Hereinafter, modifications of the above-described exemplary embodiments are listed. The modifications described below can be applied in appropriate combinations.

Chip resistor 101 may be a thin film chip resistor.

The number of the trimming grooves is not particularly limited.

The trimming grooves may include curve lines or other shapes in addition to a straight shape.

### Aspects

The present specification discloses the following aspects.

The chip resistor (101, 101A, 101B, 101C) according to the seventh aspect includes a substrate (102, 102A, 102B, 102C), a first electrode (103, 103A, 103B, 103C), a second electrode (104, 104A, 104B, 104C), and a resistive element (105, 105A, 105B, 105C). The first electrode (103, 103A, 103B, 103C) and the second electrode (104, 104A, 104B, 104C) are provided on both ends in the first direction (Y) on one surface (121, 121A, 121B, 121C) of the substrate (102, 102A, 102B, 102C). Resistive element (105, 105A, 105B, 105C) is provided on a surface (121, 121A, 121B, 121C) of the substrate (102, 102A, 102B, 102C) between the first electrode (103, 103A, 103B, 103C) and the second electrode (104, 104A, 104B, 104C). The resistive element (105, 105A, 105B, 105C) includes a meandering part (106, 106A, 106B, 106C), and a rectangular part (107, 107A, 107B, 107C) connected to the meandering part (106, 106A, 106B, 106C) and the first electrode (103, 103A, 103B, 103C). A first trimming groove (111, 111A, 111B, 111C) and a second trimming groove (112, 112A, 112B, 112C) are formed in the rectangular part (107, 107A, 107B, 107C) and extend along the second direction (X) perpendicular to the first direction (Y) from an edge (151, 151A, 151B, 151C) of the rectangular part (107, 107A, 107B, 107C) extending in the first direction (Y), thus providing the rectangular part (107, 107A, 107B, 107C) with a meandering shape.

Since this aspect reduces the potential difference between both sides of each trimming groove, even when a chip resistor is used at high voltage, insulation breakdown is less likely to occur in the trimming groove. Therefore, characteristic abnormality is less likely to occur, and a chip resistor that is excellent in electric resistance value accuracy can be obtained.

In the chip resistor (101, 101A, 101B, 101C) according to the eighth aspect, in the seventh aspect, the first trimming groove (111, 111A, 111B, 111C) is closer to the first electrode (103, 103A, 103B, 103C) than the second trimming groove (112, 112A, 112B, 112C) in the first direction (Y). The first trimming groove (111, 111A, 111B, 111C) is longer than the second trimming groove (112, 112A, 112B, 112C).

This aspect reduces the potential difference across the both sides of each trimming groove as compared with the resistor having grooves with the same length, so that insulation breakdown is less likely to occur.

In the chip resistor (101A) according to the ninth aspect, in the eighth aspect, the first trimming groove (111A) includes a straight part (211A) and a tip end part (212A) extending from the tip end of straight part (211A) toward first electrode (103A).

This aspect reduces concentration of electric current on the tip end part of the trimming groove, and suppresses characteristic abnormality due to overload. Furthermore, laser trimming tends to produce microcracks in the travelling direction, resulting in occurrence of variations in the resistance value. However, according to this aspect, an inclined tip end part suppresses a change of the resistance value due to microcracks, and therefore, reduces variations of the resistance value of the chip resistor.

In the chip resistor (101, 101A, 101B) according to a tenth aspect, in any one of the seventh to ninth aspects, the rectangular part (107, 107A, 107B) is a first rectangular part (107, 107A, 107B). The edge (151, 151A, 151B, 151C) is a first edge (151, 151A, 151B, 151C). The chip resistor (101, 101A, 101B) further includes a second rectangular part (108, 108A, 108B) connected to a second electrode (104, 104A, 104B), and has a third trimming groove (113, 113A, 113B) and a fourth trimming groove (114, 114A, 114B) formed in the second rectangular part (108, 108A, 108B) and extending in the second direction (X) from a second edge (152, 152A, 152B) of the second rectangular part (108, 108A, 108B) extending in the first direction (Y).

This aspect expands an adjustable range of the resistance value by adjusting the resistance value in the vicinity of the electrodes on both sides, thereby enhancing the accuracy of the resistance value adjustment.

In the chip resistor (101, 101A, 101B) according to an eleventh aspect, in the tenth aspect, the third trimming groove (113, 113A, 113B) is closer to the remaining electrode than the fourth trimming groove (114, 114A, 114B) in the first direction (Y). The length of third trimming groove (113, 113A, 113B) is larger than the length of the fourth trimming groove (114, 114A, 114B).

This aspect reduces the potential difference across the both sides of each trimming groove as compared with the resistor having the grooves with the same length, so that insulation breakdown is less likely to occur.

In the chip resistor (101A) according to the twelfth aspect, in the eleventh aspect, the third trimming groove (113A) includes a straight part (231A) and tip end part (232A) extending from the tip end of the straight part (231A) toward a second electrode (104A).

This aspect reduces concentration of electric current on the tip end of the trimming groove, and suppresses characteristic abnormality due to overload. Furthermore, laser trimming often tends to produce microcracks in the travelling direction, resulting in occurrence of variations in the resistance value. However, according to this aspect, an inclined tip end part, changes in resistance value due to microcracks can be suppressed, and therefore, reduces variations in the resistance value of the chip resistor.

A method for manufacturing a chip resistor (101, 101A, 101B, 101C) according to a thirteenth aspect includes: forming a first electrode (103, 103A, 103B, 103C) and a second electrode (104, 104A, 104B, 104C) on both ends of one surface of a substrate (102, 102A, 102B, 102C) in the first direction (Y); forming a resistive element (105, 105A, 105B, 105C) in a middle of the one surface (121, 121A, 121B, 121C) of the substrate (102, 102A, 102B, 102C) in the first direction, the resistive element (105, 105A, 105B, 105C) including a meandering part (106, 106A, 106B, 106C) and a rectangular part (107, 107A, 107B, 107C) connected to the meandering part (106, 106A, 106B, 106C) and a first electrode (103, 103A, 103B, 103C); and forming a first trimming groove (111, 111A, 111B, 111C) and a second trimming groove (112, 112A, 112B, 112C) in the rectangular part (107, 107A, 107B, 107C), the first trimming groove (111, 111A, 111B, 111C) and the second trimming groove (112, 112A, 112B, 112C) extending along the second direction (X) perpendicular to the first direction (Y) from an edge (151, 151A, 151B, 151C) of the rectangular part (107, 107A, 107B, 107C) extending in the first direction (Y) to provide the rectangular part (107, 107A, 107B, 107C) with a meandering shape.

This aspect reduces the potential difference between both sides of each trimming groove even when the chip resistor is used at high voltage, causing insulation breakdown to be less likely to occur in the trimming groove. Therefore, characteristic abnormality is less likely to occur, and a chip resistor that is excellent in electric resistance value accuracy can be obtained.

In the method for manufacturing the chip resistor (101, 101A, 101B, 101C) according to the fourteenth aspect, in the thirteenth aspect, the first trimming groove (111, 111A, 111B, 111C) is close to one electrode side of the second trimming groove (112, 112A, 112B, 112C) in the first direction (Y). The length of the first trimming groove (111, 111A, 111B, 111C) is larger than the length of the second trimming groove (112, 112A, 112B, 112C).

According to this aspect, the potential difference applied to the both sides of each trimming groove is reduced as compared with a resistor having grooves therein with the same length, and insulation breakdown is less likely to occur.

In a method for manufacturing the chip resistor (101A) according to a fifteenth aspect, in the fourteenth aspect, the first trimming groove (111A) includes a straight part (211A) and a tip end part (212A) extending from the tip end of the straight part (211A) toward the first electrode (103A).

This aspect reduces concentration of electric current on the tip end of the trimming groove, and suppresses characteristic abnormality due to overload. Furthermore, laser trimming tends to produce microcracks in the travelling direction, resulting in variations in the resistance value. However, according to this aspect, the trimming groove with an inclined tip end suppresses a change of the resistance value due to the microcracks, and therefore, reduces variations in the resistance value in the chip resistor.

### REFERENCE MARKS IN THE DRAWINGS

1, 1A, 1B, 1C, 1D chip resistor
2, 2B, 2C, 2D insulating substrate (substrate)
3, 3C first upper surface electrode (electrode)
4, 4C second upper surface electrode (electrode)
5, 5B, 5C, 5D resistive element
11 sixth rectangular part (connection section)
11C connection section
12, 12A, 12B, 12C, 12D resistance value adjusting part
14, 14A, 14B, 14C, 14D second edge (groove-starting edge)
15, 15A, 15B, 15C, 15D meandering part
16, 16A, 16B, 16C, 16D first trimming groove
17, 17A, 17B, 17C, 17D second trimming groove
16P1, 16A1, 16B1, 16C1, 16D1 first straight part
17P1, 17A1, 17B1, 17C1, 17D1 second straight part
17P2, 17A2, 17B2, 17C2, 17D2 bent part
21, 21C surface
31 first connection part
32 second connection part
49 edge
50 edge
101, 101A, 101B, 101C chip resistor
102, 102A, 102B, 102C insulating substrate
103, 103A, 103B, 103C first upper surface electrode
104, 104A, 104B, 104C second upper surface electrode
105, 105A, 105B, 105C resistive element
106, 106A, 106B, 106C meandering part
107, 107A, 107B first rectangular part
107C rectangular part
108, 108A, 108B second rectangular part
111, 111A, 111B, 111C first trimming groove
112, 112A, 112B, 112C second trimming groove
113, 113A, 113B third trimming groove
114, 114A, 114B fourth trimming groove
115B fifth trimming groove
116B sixth trimming groove

1. A chip resistor comprising:
a substrate;
a pair of electrodes provided on both ends of one surface of the substrate; and
a resistive element provided on the one surface of the substrate between the pair of electrodes, wherein
the resistive element includes:
a pair of connection parts arranged along a first direction, the pair of connection parts being connected to the pair of electrodes, respectively, and
a resistance value adjusting part provided between the pair of connection parts,
the resistance value adjusting part includes a meandering part providing the resistance value adjusting part with a meandering shape,
the meandering part has a first trimming groove and a second trimming groove therein,
the first trimming groove and the second trimming groove are arranged along the first direction,
the first trimming groove includes a first straight part extending from a groove-starting edge of the resistance value adjusting part along a second direction perpendicular to the first direction, and
the second trimming groove includes a second straight part and a bent part, the second straight part extending from the groove-starting edge of the resistance value adjusting part along the second direction, the bent part extending from a tip end of the second straight part in a direction approaching the first trimming groove.

2. The chip resistor according to claim 1, wherein a length of the second straight part in the second direction is larger than a length of the first straight part in the second direction.

3. The chip resistor according to claim 1, wherein the bent part of the second trimming groove is opposite to the groove-starting edge with respect to a tip end of the first straight part of the first trimming groove.

4. The chip resistor according to claim 1, wherein the bent part includes a folded part folded with respect to the second straight part.

5. The chip resistor according to claim 4, wherein the folded part of the second trimming groove includes a circular arc part.

6. The chip resistor according to claim 1, wherein
each of the pair of connection parts is provided in a vicinity of the groove-starting edge, and includes a connection section connected to the resistance value adjusting part, and
a1/b1≥0.53 and a1/b1≤1.30 are satisfied, where a1 is a length of the second trimming groove from an edge of the connection section opposite to the groove-starting edge to a tip end of the second trimming groove, and b1 is a length of the first trimming groove from the edge of the connection section to a tip end of the first trimming groove.

7. A chip resistor comprising:
a substrate;
a first electrode and a second electrode provided on both ends of one surface of the substrate in the first direction; and
a resistive element provided on the one surface of the substrate between the first electrode and the second electrode, wherein
the resistive element includes:
a meandering part, and
a first rectangular part connected to the meandering part and the first electrode,
the first rectangular part has a first trimming groove and a second trimming groove provided therein extending along a second direction perpendicular to the first direction from a first edge of the first rectangular part extending in the first direction part, the first trimming groove and the second trimming groove providing the first rectangular part with a meandering shape.

8. The chip resistor according to claim 7, wherein
the first trimming groove is closer to the first electrode than the second trimming groove along the first direction, and
a length of the first trimming groove is larger than a length of the second trimming groove.

9. The chip resistor according to claim 8, wherein the first trimming groove includes:
a straight part; and
a tip end part extending toward the first electrode from a tip end of the straight part.

10. The chip resistor according to claim 7, wherein
the resistive element further includes a second rectangular part connected to the second electrode, wherein
the second rectangular part has a third trimming groove and a fourth trimming groove therein extending along the second direction from a second edge of the second rectangular part extending in the first direction.

11. The chip resistor according to claim 10, wherein
the third trimming groove is closer to the second electrode than the fourth trimming groove along the first direction, and
a length of the third trimming groove is larger than a length of the fourth trimming groove.

12. The chip resistor according to claim 11, wherein the third trimming groove includes:
a straight part, and
a tip end part extending toward the second electrode from a tip end of the straight part.

13. A method for manufacturing a chip resistor, comprising:
forming a first electrode and a second electrode on both ends of one surface of a substrate in a first direction;
forming, on a middle of the one surface of the substrate in the first direction, a resistive element including a meandering part and a rectangular part connected to the meandering part and the first electrode; and
forming a first trimming groove and a second trimming groove in the rectangular part, the first trimming groove and the second trimming groove extending along a second direction perpendicular to the first direction from an edge of the rectangular part extending in the first direction so as to providing the rectangular part with a meandering shape.

14. The method according to claim 13, wherein
the first trimming groove is closer to the first electrode than the second trimming groove along the first direction, and
a length of the first trimming groove is larger than a length of the second trimming groove.

15. The method according to claim 14, wherein the first trimming groove includes:
a straight part, and
a tip end part extending toward the first electrode from a tip end of the straight part.
